(19) United States
(12) Patent Application Publication
(10) Pub. No.: US 2005/0097032 A1
(43) Pub. Date: May 5, 2005

(54) Network support for automatic credit for dropped calls

(75) Inventors: David S. Benco, Winfield, IL (US); Kevin J. Overend, Elmhurst, IL (US); Baoling S. Sheen, Naperville, IL (US); Sandra Lynn True, St. Charles, IL (US); Kenneth J. Voight, Sugar Grove, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114, US

(73) Assignee: Lucent Technologies Inc.

(21) Appl. No.: 10/696,644

(22) Filed: Oct. 29, 2003

(51) Int. Cl. G06F 17/60

(52) U.S. Cl. 705/38

(57) ABSTRACT

A credit is automatically applied to an account of a subscriber when an interruption in subscribed services is detected. For example, the credit may be a monetary credit or a credit of a service, such as, airtime. A subscriber database record may indicate a preferred type of credit. A call data record may be used to apply the credit. The subscriber may be automatically notified of the applied credit. For instance, a voice mail or text message is generated and stored. The subscriber is notified that a message has been stored. At the subscriber's convenience, the message is retrieved. The message may indicate the amount and type of credit and may include an explanation and/or expression of regret for the interrupted service.

### BACKGROUND OF THE INVENTION

The following disclosure is directed to the art of applying credit to an account of a network communications subscriber. Embodiments will be described in reference to mobile telecommunications networks. However, the disclosed subject matter can be applied in other communications systems.

Communications service subscribers expect error free communication services in exchange for their subscription fees. Nevertheless, communications services can become degraded and/or interrupted. For example, a network link can become overwhelmed with network traffic and data packets can be lost or delayed. Additionally, physical equipment can be broken or destroyed, can malfunction, or experience interference. Furthermore, a communication services subscriber using mobile equipment can move out of range of a serving cell site of a communications network and/or into a shadow of an obstruction between the serving cell site and the mobile equipment of the subscriber. Each of these factors, in and of themselves, or in combination with other factors, can cause an episode of communications interruption and associated subscriber frustration and dissatisfaction.

Communication interruption episodes generate a large number of customer service calls from subscribers wishing to register complaints about the disruptions and/or subscribers requesting credit due to interruptions in services they have experienced. Furthermore, frustrated subscribers may cancel their communication service subscriptions and/or change communications service providers.

While communication service providers strive to eliminate communications disruptions through technological innovation and network expansion, communications disruptions are likely to occur for the foreseeable future. Therefore, there is a desire for other means for reducing communications service subscriber frustration. For instance, there is a desire for a means to automatically compensate a subscriber for the inconvenience of interrupted communications, by, for example, automatically providing credit to an account of a communications service subscriber when communications services of the subscriber are interrupted.

### SUMMARY OF THE INVENTION

A method for automatically providing credit to an account of a communications services subscriber when communications services of the subscriber are interrupted includes detecting an interruption in communication services of the subscriber, generating a communications interrupted message describing the detected interruption in communication services of the subscriber, transmitting the communications interrupted message, generating a credit account message based on the communications interruption message, transmitting the credit account message to a billing center and applying a credit to the account of the subscriber based on the credit account message.

Some embodiments further include generating a subscriber notification message describing the credit and transmitting the subscriber notification message to user equipment of the subscriber. Some of those embodiments include storing the generated subscriber notification until communications services are reestablished with the user equipment of the subscriber.

Detecting the interruption in the communication services of the subscriber can include noting a lack of response from the user equipment of the subscriber, noting a time of the lack of response and declaring the communication services of the subscriber interrupted when a difference between the noted time and a current time exceeds a predetermined value. For example, detecting the interruption in the communication services can be performed at a cell cite serving the user equipment of the subscriber. Generating the communications interrupted message can also occur at the cell site serving the user equipment of the subscriber.

Transmitting the communications interrupted message can include transmitting the communications interrupted message from the cell site to a mobile switching center serving the user equipment of the subscriber.

Applying the credit to the account of the subscriber can include generating a call data record applying credit to the account of the subscriber. Additionally, applying credit to the account of the subscriber can include, for example crediting air time and/or a monetary credit to the account of the subscriber. Furthermore, applying the credit to the account of the subscriber can include determining a credit type preference of the subscriber and applying a credit to the account of the subscriber based on the determined credit type preference of the subscriber.

A system for automatically providing credit to an account of a communications services subscriber when communications services of the subscriber are interrupted can include means for detecting an interruption in communication services of the subscriber, means for generating a communications interrupted message describing the detected interruption in communication services of the subscriber, means for transmitting the communications interrupted message, means for generating a credit account message based on the communications interruption message, means for transmitting the credit account message to a billing center and means for applying a credit to the account of the subscriber based on the credit account message.

Some embodiments also include means for generating a subscriber notification message describing the credit and means for transmitting the subscriber notification message to user equipment of the subscriber. Some of those embodiments include means for storing the generated subscriber notification until communications services are reestablished with the user equipment of the subscriber.

The means for detecting the interruption in the communication services of the subscriber can include means for noting a lack of response from the user equipment of the subscriber, means for noting a time of the lack of response and means for declaring the communication services of the subscriber interrupted when a difference between the noted time and a current time exceeds a predetermined value.

The means for applying the credit to the account of the subscriber can include means for generating a call data record applying credit to the account of the subscriber. Furthermore, the means for applying the credit to the account of the subscriber can include means for determining a credit type preference of the subscriber and means for applying a credit to the account of the subscriber based on the determined credit type preference of the subscriber.

For example, the means for detecting the interruption in the communication services of the subscriber can include means for noting a signal strength from the user equipment of the subscriber, means for comparing the signal strength to a threshold signal strength and means for declaring the communication services of the subscriber interrupted when the signal strength falls below the threshold signal strength. Additionally, or alternatively, the means for detecting the interruption in the communication services of the subscriber can include means for noting a signal strength from the user equipment of the subscriber means for comparing the signal strength to a threshold signal strength and, for example, means for declaring the communication services of the subscriber interrupted when the signal strength falls below the threshold signal strength for a predetermined period of time. Additionally or alternatively the means for detecting the interruption in the communication services of the subscriber can include means for declaring the communication services of the subscriber interrupted when the signal strength falls below the threshold signal strength with at least a predetermined frequency and/or means for declaring the communication services of the subscriber interrupted when the signal strength falls below the threshold signal strength with a predetermined number of times.

Some systems that are operative to automatically apply a credit to an account of a communications services subscriber include an interruption event processor and a dropped call detector. For example, the interruption event processor is operative to direct the application of credit to the account of the communications services subscriber based on a description of a communications interruption event involving the subscriber. The a dropped call detector can be operative to detect a communications interruption event involving user equipment of the subscriber and to provide the description of the dropped call event to the interruption event processor.

Some embodiments include a subscriber database including a record indicated a credit type preference of the subscriber wherein interruption event processor is operative to read the record indicating the credit type preference of the subscriber and direct an application of a credit according to the read preference.

Some embodiments include a notification processor operative to direct the generation of a notification message informing the subscriber that credit is being applied to the account of the subscriber.

Some embodiments include a message storage device operative to store the notification message at least until communications services are restored to the user equipment of the subscriber and the notification message is delivered to the user equipment of the subscriber.

The interruption event processor can be operative to calculate a credit amount based on information received in the description of the dropped call event. Additionally, or alternatively, the interruption event processor can be further operative to calculate a credit amount based on information received in the description of the dropped call event and information received from a subscriber record associated with the subscriber.

### BRIEF DESCRIPTION OF THE DRAWINGS

The invention may take form in various components and arrangements of components, and/or in various procedures and arrangements of procedures. The drawings are only for purposes of illustrating preferred embodiments. They are not to scale, and are not to be construed as limiting the invention.

FIG. 1 is a flow chart outlining a method for providing credit to an account of a communications services subscriber when communications services of the subscriber are interrupted.

FIG. 2 is a flow chart outlining a method for notifying the subscriber of the application of a credit to the account of the subscriber.

FIG. 3 is a call flow diagram outlining an exemplary call flow scenario associated with the method of FIG. 1.

FIG. 4 is a call flow diagram outlining an exemplary call flow scenario associated with the method of FIG. 2.

FIG. 5 is a block diagram illustrating a system that is operative to perform the methods of FIGS. 1 and 2.

### DETAILED DESCRIPTION OF THE INVENTION

Referring to FIG. 1, a method 110 for automatically providing credit to an account of communications services subscriber when communications services of the subscriber are interrupted includes detecting 114 an interruption in communications of the subscriber, generating 118 a Communications Interrupted message describing the interruption, transmitting 122 the Communications Interrupted message, generating 126 a credit account message, transmitting 130 the credit account message to a Billing Center, and applying 134 a credit to an account of the subscriber according to the Credit Account message.

An interruption in communications of a subscriber can be defined and detected in a number of ways. For example, an interruption in communications service can be declared when a signal strength from a mobile device of the subscriber drops below a threshold signal strength. Alternatively, an interruption can be declared when the signal strength of the mobile device drops below the threshold a predetermined number of times, or with a predetermined frequency, or for a predetermined period of time. Additionally, or alternatively, an interruption in service can be detected or declared when no response is received from the mobile device for a predetermined period. For example, a time between the reception of valid frames is measured. If the time between the reception of valid frames extends beyond a valid frame detection threshold period, an interruption in communications is declared or detected 114.

Generating 118 a communications interrupted message can be performed by, for example, a Base Station or Radio Node Controller associated with a Base Station of a Cell Site serving Mobile Equipment of the subscriber. For instance, the Cell Site may generate a message identifying the subscriber and including a flag or parameter indicating that a communications error has occurred. For example, the subscriber may be identified by an International Mobile Subscriber Identity (IMSI) associated with the Mobile Equipment of the subscriber. The error flag or parameter may simply indicate that an error has occurred. Alternatively, an error parameter may include more information. For instance, an error parameter may indicate that a call was lost or dropped entirely, that the subscriber experienced broken or delayed transmission or reception of information, or that the subscriber experienced noise or interference.

Transmitting 122 the Communications Interrupted message can include, for example, transmitting the Communications Interrupted message from a network element that generated 118 the message, such as a Cell Site serving the subscriber, to a network element that can take action based on the message. For example, the Communications Interrupted message is transmitted 122 to a Switching Center, such as, a Mobile Switching Center (MSC) or a Switching Center of a wired network.

Generating 126 a Credit Account message can include determining the type of credit to apply to an account of the subscriber. For example, the network element or Switching Center may query a Subscriber Database to determine if the subscriber prefers credits in the form of monetary amounts or in the form of free air time. Additionally, a Switching Center may calculate or determine a credit amount. For example, if the transmitted 122 Communications Interrupted message only indicates that a communications interruption occurred, then the credit amount may simply be some predetermined default amount. However, if the generated 118 and transmitted 122 Communications Interrupted message includes additional information, then the amount of the credit may be calculated based on that information. For instance, if the Communications Interrupted message includes information regarding the duration of the call, before and/or after the communications interruption event the credit calculation may be based on that duration. For example, longer calls may warrant larger credits. Furthermore, if the Communications Interrupted message includes information regarding the type of communications interruption that was experienced (e.g., dropped call, noise, brief episodes of “breaking up”) the interruption type may be factored into the credit calculation.

The generated 126 Credit Account message is transmitted 130 to a Billing Center where it is processed 134. For instance, a financial amount owed by the subscriber is reduced by the credit amount, or a number of free or prepaid air time minutes available to the subscriber is increased by an amount indicated in the transmitted 130 credit account message. For instance, the air time credit may be applied 134 to the current billing period, the next billing period, or may be applied 134 in a “roll over manner”, so that the credited air time may be used at any point in the future desired by the subscriber. When the subscriber reviews a next available account statement, the subscriber will see that the credit has been applied.

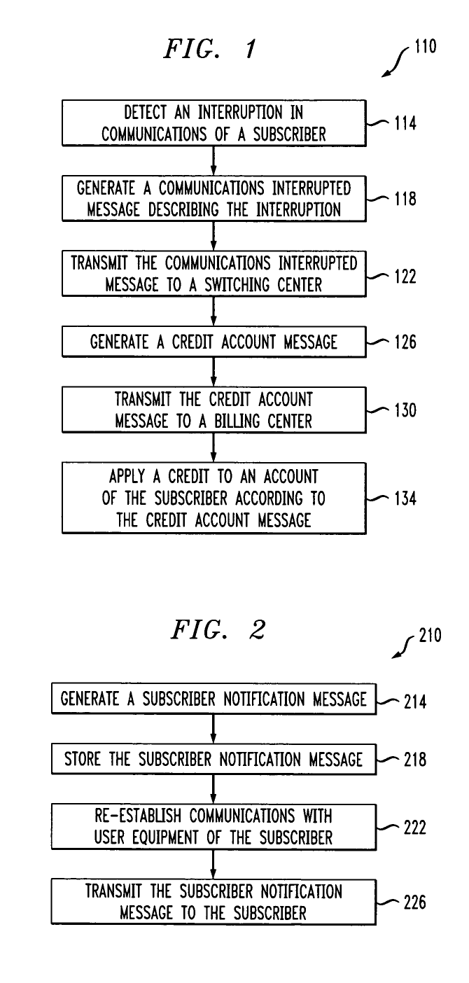

Referring to FIG. 2, additionally, the method 110 for automatically providing credit to an account of a communications service subscriber can include providing 210 more immediate credit notification. For instance, providing 210 more immediate credit notification can include generating 214 a Subscriber Notification message, storing 218 the Subscriber Notification message, reestablishing 222 communications with the User Equipment of the subscriber, and transmitting 226 the subscriber notification message to the subscriber.

Generating 214 the Subscriber Notification message can include generating, for example, a Short Message Service (SMS) based Notification message, or a Voice Mail message.

If the notification is generated 214 before communications is reestablished 222 with the User Equipment of the subscriber, then the notification is stored 218. For example, the notification is stored in a Voice Mail Service or Text Message Service of the subscriber.

When the subscriber recharges or replaces the power source of the mobile device, moves out of the shadow of the obstruction, or moves within range of a serving cell site, communications can be reestablished 222 with the user equipment of a subscriber. At that point, the Notification message can be transmitted 226 to the user equipment of the subscriber.

For instance, a display on the user equipment of the subscriber may indicate that a voice mail message or text message is available for retrieval. The subscriber may opt to retrieve the voice mail message immediately, or delay retrieval until a more convenient time. Whenever the subscriber retrieves the message it is transmitted 226 to the subscriber, thereby informing the subscriber that a compensating credit has been applied to the account of the subscriber. Additionally, the notification may include additional messages, such as, for example, an expression of appreciation for the subscriber's business, a statement of regret regarding the inconvenience of the communications interruption, an explanation of the cause of the communications interruption, and/or a statement regarding continued attempts to improve communications services.

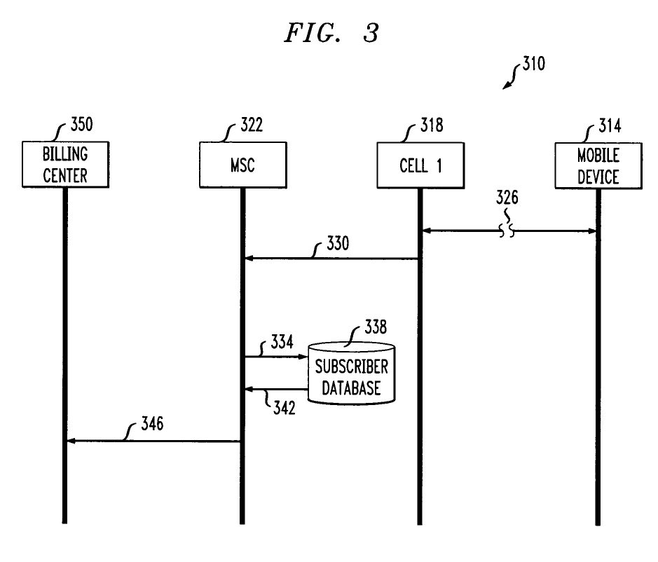

Referring to FIG. 3, in an exemplary scenario 310, a subscriber uses a Mobile Device 314 to communicate with a second party or device (not shown) through the services of a first Cell Site 318, a serving MSC 322 and an interconnecting network (not shown). At some point during the communications session the communications of the subscriber are interrupted 326. For instance, the subscriber (and Mobile Device 314) moves into a signal blocking shadow of an obstruction between the Cell Site 318 and the Mobile device 314 causing a dropped call type communications disruption. The first Cell Site 318 detects 114 the disruption 326, with, for example, a dropped call detector (not shown), generates 118 a Communications Interrupted message 330 and transmits 122 the Communications Interrupted message 330 to the Mobile Switching Center 322.

The Mobile Switching Center extracts information regarding the identity of the subscriber associated with the Mobile Device 314 and the communications interruption 326 from the Communications Interrupted message 330. The MSC 322 uses the extracted information to generate a Query or Dip 334 into a Subscriber Database 338 associated with the subscriber using the mobile device 314. The Query 334 requests information regarding preferences of the subscriber related to a desired type of credit. Additionally, the Query 334 may request communications interruption history information regarding the subscriber. The Subscriber Database 338 generates and transmits a Query Response message 342 including the requested information. The MSC 322 uses information from the Communications Interrupted messages 330 and the Query Response message 342 to generate 126 a Credit Account message 346. As explained above, the credit to be applied may simply be a predetermined amount which is credited whenever any kind of communications interruption is detected 114. The credit may be of any desired type such as a monetary credit or an air time credit based on the preference of the subscriber reported in the Query Response 342 or as determined by the service provider. Alternatively, the credit may be a function of parameters such as, for example, a kind of interruption, a duration of interruption, and a severity of interruption, as may be reported in the Communications Interrupted message 330. Furthermore, the credit may be a function of a communications interruption history of the subscriber. For instance, if the subscriber has suffered a number of communications interruptions in the recent past, a credit value may be increased. Alternatively, a credit cap may be applied, thereby preventing an excessive amount of credit from being applied to the account of a subscriber. When the credit amount is calculated or determined, a Credit Account Message 346 is transmitted 130 to a Billing Center 350 associated with the subscriber. The Billing Center 350 applies 134 credit to an account of the subscriber according to instructions in the Credit Account message 346.

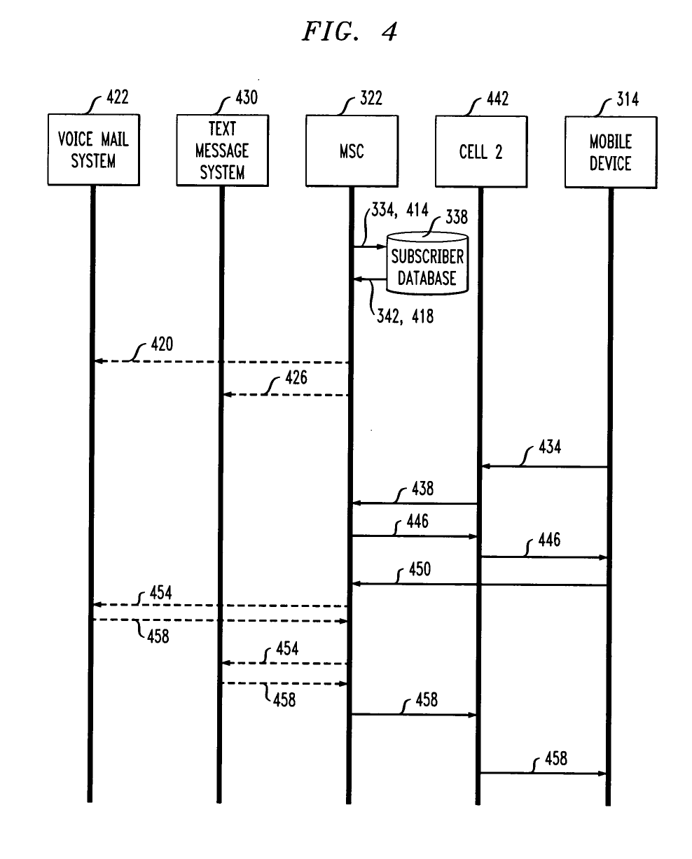

Referring to FIG. 4, as indicated above, the subscriber may be notified that a credit has been posted to the account of the subscriber, thereby indicating the concern of the service provider regarding interrupted communications, relieving the subscriber from the task of having to call a customer service representative to report the communications disruption and request credit and generally maintaining good customer relations. For instance, the MSC 322 may query the subscriber database 338 to determine a notification preference of the subscriber. For example, the MSC 322 requests information regarding the subscriber's preference for Voice Mail notification or Text Message notification. The request may be included in the Query or Dip 334 associated with the request for credit type preferences, described above, or the query may be a second Query 414 specifically related to notification preferences. The Subscriber Database 338 responds with a Query Response message. The Query Response message may be the Query Response message 342 associated with the credit type query 334, or may be a second Query Response message 418 specifically related to the notification type preference.

If the Query Response 342, 418 indicates that a Voice Message notification is preferred, the MSC 322 generates and transmits a message 420 requesting that a Voice Mail System 422 generate 214 a Subscriber Notification message explaining that a credit has been applied to the account of the subscriber in response the detection of a communications session interruption. For example, the Voice Mail System 422 includes a voice synthesizer or text to voice converter and the message 420 includes a text version of a notification message. The Voice Mail System 422 converts the text version of the message to a voice message and delivers the voice message to a Voice Mail Box associated with the subscriber, thereby storing 218 the notification message.

If the Query Response 342, 418 indicates that the subscriber prefers text message notifications, the MSC 322 generates and transmits a Text Notification message 426 to a Text Message System 430. For instance, the Text Notification message 426 includes text explaining that a credit has been applied to the account of the subscriber as compensation for the detected communications session interruption. Additionally, the notification may include other information, such as, for example, expressions of regret and/or explanations regarding the cause of the interruption. The Text Message system 430 delivers the text of the notification to a Text Message Mail Box of the subscriber, thereby storing 218 the subscriber notification message.

When communications is reestablished 222, 434 with the Mobile Device 314 of the subscriber, the Cell Site serving the Mobile Device 314 notifies 438 the MSC 322. For instance, if the Mobile Device 314 is moved out of the shadow of an obstruction and is able to reestablish communication with the first Cell Site 318, or if the Mobile Device 314 is moved within range of a second Cell Site 442, communications may be reestablished 222, 434. In response to the notification 438 that communications has been reestablished, the MSC 322 sends messages (not shown) to determine if the subscriber subscribes to voice mail or text message services, and if so, sends messages to determine if any messages are pending for the subscriber. Since a credit notification message is pending for the subscriber the MSC 322 sends a Message Waiting message 446 to the Mobile Device 314 of the subscriber. In response, the Mobile Device 314 displays an indication that a message is pending. For example a text message is displayed or a light is illuminated to alert the subscriber that a message is pending. At a time convenient to the subscriber, the subscriber takes action to retrieve the pending message. The Mobile Device 314 transmits a Retrieve Voice or Text Mail message 450 to the MSC 322 and the MSC transmits an appropriate message 454 requesting the delivery of the pending voice mail or text message to the Voice Mail System 422 or Text Message System 430, as appropriate. As a result, the Voice Mail System 422 or Text Message System 430 transmits 226 the Notification message 458 to the Mobile Device 314 through the services of the MSC 322 and the Cell Site 422.

A system operative to automatically provide credit to an account of a communications services subscriber when communications services of the subscriber are interrupted can include means for detecting an interruption in communications services, means for generating a communications interrupted message describing the interruption in communication services, means for transmitting the communications interrupted message, means for generating a credit account message based on the communications interrupted message, means for transmitting the credit account message to a billing center and means for applying credit to the account of the subscriber based on the credit account message.

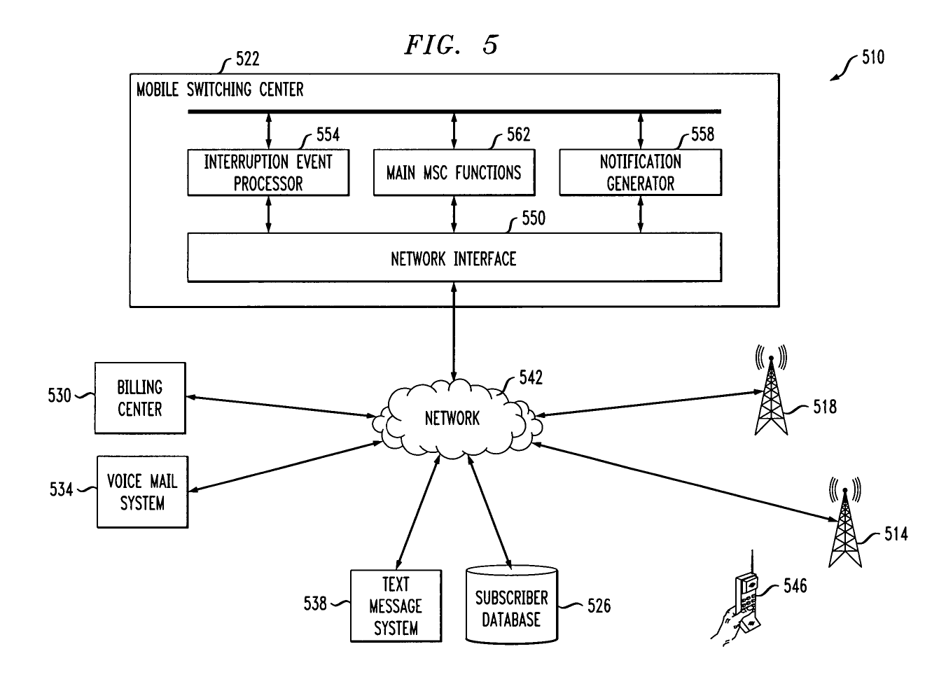

For example, referring to FIG. 5, a system 510 operative to automatically provide credit to an account of communications services subscriber when communications services of the subscriber are interrupted includes one or more Cell Sites 514, 518, a Mobile Switching Center 522, a Subscriber Database 526, a Billing Center 530, a Voice Mail System 534 and/or a Text Message System 538 and a Network 542 interconnecting network elements (e.g., 514, 518, 522, 526, 530, 534, 538).

The Cell Sites 514, 518 include one or more communications interruption detectors (not shown). The communications interruption detectors may monitor the strength of a signal receives from a Mobile Device 546 of the subscriber. If the signal strength falls below a predefined threshold, falls below a predefined threshold for a predefined period of time and/or falls below a threshold a predetermined number of times within a predefined period of time, the communications interruption detectors may declare or detect 114 a communications interruption. Alternatively, or additionally if no valid frames or data packets are received from the Mobile Device 546 of the subscriber for a predefined period of time during a communications session, the communications interruption detectors may declare or detect 114 a communications interruption. If, or when, a communications interruption is detected, the Serving Cell Site 514 or 518 generates 118 a Communications Interrupted message and transmits 122 the Communications Interrupted message to the Mobile Switching Center 522. The Communications Interrupted message may simply indicate a communications error has occurred. Alternatively, a Communications Interrupted message may include a more detailed description of the interruption event. For example, the Communications Interrupted message may describe the severity and/or duration of the communications interruption event. For instance, communications interruptions may range from dropped calls to calls that include periods of choppiness or broken up conversation, or conversation combined with static or other kinds of noise.

The Mobile Switching Center 522 includes a Network Interface 550, an Interruption Event Processor 554, a Notification Generator 558 and Main MSC Functions 562. When the MSC 522 receives the Communications Interrupted message from the Serving Cell Site 514, 518 through the services of the interconnecting Network 542, the Network Interface 550 passes the Communications Interrupted message to the Main MSC Functions 562. The Main MSC Functions 562 pass the Communications Interrupted message to the Interruption Event Processor 554. The Interruption Event Processor 554 generates 126 a Credit Account message and transmits 130 the Credit Account message to the Billing Center 530 through the services of the Network Interface 550 and the intervening Network 542.

For example, the Interruption Event Processor 554 extracts subscriber identification information from the Communications Interrupted Message and accesses a subscriber database record in the Subscriber Database 526. For instance, the subscriber database record includes a subscriber preference with regard to a type of credit to be applied to the account of the subscriber in the event of a communications interruption. For instance, the subscriber record indicates that the subscriber prefers credits in the form of air time. Alternatively, the subscriber is not given a choice of credit types and the Interruption Event Processor 554 generates 126 a Credit Account message directing the application of credit of a type determined by the communications service provider.

As indicated above, the subscriber record from the Subscriber Database 526 may also include other information relevant to the calculation of a credit amount. For instance, a communications interruption history of the subscriber may be a factor in calculating a credit amount. Additionally, or alternatively, a quality of service subscribed for by the subscriber may be a factor in determining the credit amount. The Communications Interrupted message may include, or the MSC 522 may be aware of, parameters associated with the interrupted communications session that may be factors in the credit amount of calculation. For instance, a communications session or call length prior to and/or subsequent to the communications interruption event may be a factor in determining the credit amount. For instance, the credit amount may simply be based on the number of air time minutes consumed in the communications session or call prior to the communications interruption event or the total number of minutes consumed both before and after the communications interruption event.

Once the Interruption Event Processor 554 determines the credit amount and the credit type, the Interruption Event Processor 554 generates 126 the Credit Account message and transmits 130 the Credit Account message to the Billing Center 530.

The Billing Center 530 then applies 134 a credit to the account of the subscriber according to information received in the Credit Account message. The Billing Center 530 may transmit an Acknowledgement message, indicating that the credit has been applied, back to the Interrupt Event Processor 554. Alternatively, the Interruption Event Processor 554 assumes that the credit will be applied. In either case, the Interruption Event Processor 554 passes information regarding the credit to the Notification Generator 558. The Notification Generator 558 generates 214 a Subscriber Notification message and orchestrates the transmission 226 of the Subscriber Notification message to the subscriber. For example, the Notification Generator 558 accesses the subscriber record of the subscriber in the Subscriber Database 526 to determine if the subscriber prefers voice mail or text message credit notifications. Alternatively, the Interruption Event Processor 554 retrieves this information from the database Query Response received from the Subscriber Database 526 first discussed in reference to subscriber credit type preferences, and passes this information to the Notification Generator 558. Alternatively, the subscriber notification method is determined by the communications services provider.

Once the notification delivery method is determined, the Notification Generator 558 generates messages directing system or network components to create and optionally store the notification message. For example, if the preferred notification method is via voice mail, the Notification Generator 558 generates a message directing a Voice Mail System 534 to synthesize a voice message notifying the subscriber that a credit has been applied to the account of the subscriber. The voice message may include, for example, a type and amount of the credit, as well as an expression of regret regarding the inconvenience of the communications interruption, or any other message the communication service provider wishes to convey. In response, the Voice Mail Message System 534 synthesizes the notification and stores the notification in a voice mail account of the subscriber. Alternatively, if the preferred notification method is a text message, the Notification Generator 558 creates and transmits a message directing the Text Message System 538 to store 218 a text notification in a text message account of the subscriber. Again, the notification can include the credit amount, credit type, and other messages from the communications service provider.

When the Mobile Device 546 reestablishes 222 communication with the system 510, for example, by moving within range of one of the Cell Sites, 514, 518, the Main MSC Functions 562 are notified. The Main MSC Functions 562 determine if the subscriber subscribes to one of more messaging services such as voice mail or text messaging, and if so, determines if any messages are pending. Since a credit notification is pending, the Main MSC Functions generate, and transmit, a message pending indication to the Mobile Device 546 of the subscriber. The Mobile Device 546 displays a message pending indication and the subscriber takes action to retrieve the pending message at some convenient time. When the subscriber retrieves the pending message, the Main MSC Functions 562 direct the Voice Mail System 534 or Text Message System 538 to transmit the credit notification message to the Mobile Device 546 of the subscriber.

The invention has been described with reference to the preferred embodiments. Obviously, modifications and alterations will occur to others upon a reading and understanding of this specification. It is intended that the invention be construed as including all such modifications and alterations insofar as they come within the scope of the appended claims or the equivalents thereof.

1. A method for automatically providing credit to an account of a communications services subscriber when communications services of the subscriber are interrupted, the method comprising:
detecting an interruption in communication services of the subscriber;
generating a communications interrupted message describing the detected interruption in communication services of the subscriber;
transmitting the communications interrupted message;
generating a credit account message based on the communications interruption message;
transmitting the credit account message to a billing center; and
applying a credit to the account of the subscriber based on the credit account message.

2. The method of claim 1 further comprising:
generating a subscriber notification message describing the credit; and,
transmitting the subscriber notification message to user equipment of the subscriber.

3. The method of claim 2 further comprising:
storing the generated subscriber notification until communications services are reestablished with the user equipment of the subscriber.

4. The method of claim 1 wherein detecting the interruption in the communication services of the subscriber comprises:
noting a lack of response from the user equipment of the subscriber;
noting a time of the lack of response; and,
declaring the communication services of the subscriber interrupted when a difference between the noted time and a current time exceeds a predetermined value.

5. The method of claim 1 wherein detecting the interruption in the communication services of the subscriber comprises:
detecting the interruption in the communication services of the subscriber at a cell cite serving the user equipment of the subscriber.

6. The method of claim 5 wherein generating the communications interrupted message comprises:
generating the communications interrupted message describing the interruption in communication services of the subscriber at the cell site serving the user equipment of the subscriber.

7. The method of claim 5 wherein transmitting the communications interrupted message comprises:
transmitting the communications interrupted message from the cell site to a mobile switching center serving the user equipment of the subscriber.

8. The method of claim 1 wherein applying the credit to the account of the subscriber comprises:
generating a call data record applying credit to the account of the subscriber.

9. The method of claim 1 wherein applying the credit to the account of the subscriber comprises:
crediting air time to the account of the subscriber.

10. The method of claim 1 wherein applying the credit to the account of the subscriber comprises:
applying a monetary credit to the account of the subscriber.

11. The method of claim 1 wherein applying the credit to the account of the subscriber comprises:
determining a credit type preference of the subscriber; and
applying a credit to the account of the subscriber based on the determined credit type preference of the subscriber.

12. A system operative to automatically apply a credit to an account of a communications services subscriber, the system comprising;
an interruption event processor operative to direct the application of credit to the account of the communications services subscriber based on a description of a communications interruption event involving the subscriber; and
a dropped call detector operative to detect a communications interruption event involving user equipment of the subscriber and to provide the description of the dropped call event to the interruption event processor.

13. The system of claim 12 further comprising:
a subscriber database including a record indicated a credit type preference of the subscriber wherein interruption event processor is operative to read the record indicating the credit type preference of the subscriber and direct an application of a credit according to the read preference.

14. The system of claim 12 further comprising:
a notification processor operative to direct the generation of a notification message informing the subscriber that credit is being applied to the account of the subscriber.

15. The system of claim 14 further comprising:
a message storage device operative to store the notification message at least until communications services are restored to the user equipment of the subscriber and the notification message is delivered to the user equipment of the subscriber.

16. The system of claim 12 wherein the interruption event processor is operative to calculate a credit amount based on information received in the description of the dropped call event.

17. The system of claim 12 wherein the interruption event processor is further operative to calculate a credit amount based on information received in the description of the dropped call event and information received from a subscriber record associated with the subscriber.

18. A system for automatically providing credit to an account of a communications services subscriber when communications services of the subscriber are interrupted, the system comprising:
means for detecting an interruption in communication services of the subscriber;
means for generating a communications interrupted message describing the detected interruption in communication services of the subscriber;
means for transmitting the communications interrupted message;
means for generating a credit account message based on the communications interruption message;
means for transmitting the credit account message to a billing center; and
means for applying a credit to the account of the subscriber based on the credit account message.

19. The system of claim 18 further comprising:
means for generating a subscriber notification message describing the credit; and,
means for transmitting the subscriber notification message to user equipment of the subscriber.

20. The system of claim 19 further comprising:
means for storing the generated subscriber notification until communications services are reestablished with the user equipment of the subscriber.

21. The system of claim 18 wherein the means for detecting the interruption in the communication services of the subscriber comprises:
means for noting a lack of response from the user equipment of the subscriber;
means for noting a time of the lack of response;
means for declaring the communication services of the subscriber interrupted when a difference between the noted time and a current time exceeds a predetermined value.

22. The system of claim 18 wherein the means for applying the credit to the account of the subscriber comprises:
means for generating a call data record applying credit to the account of the subscriber.

23. The system of claim 1 wherein the means for applying the credit to the account of the subscriber comprises:
means for determining a credit type preference of the subscriber; and
means for applying a credit to the account of the subscriber based on the determined credit type preference of the subscriber.

24. The system of claim 18 wherein the means for detecting the interruption in the communication services of the subscriber comprises:
means for noting a signal strength from the user equipment of the subscriber;
means for comparing the signal strength to a threshold signal strength; and,
means for declaring the communication services of the subscriber interrupted when the signal strength falls below the threshold signal strength.

25. The system of claim 18 wherein the means for detecting the interruption in the communication services of the subscriber comprises:
means for noting a signal strength from the user equipment of the subscriber;
means for comparing the signal strength to a threshold signal strength; and,
means for declaring the communication services of the subscriber interrupted when the signal strength falls below the threshold signal strength for a predetermined period of time.

26. The system of claim 18 wherein the means for detecting the interruption in the communication services of the subscriber comprises:
means for noting a signal strength from the user equipment of the subscriber;
means for comparing the signal strength to a threshold signal strength; and,
means for declaring the communication services of the subscriber interrupted when the signal strength falls below the threshold signal strength with at least a predetermined frequency.

27. The system of claim 18 wherein the means for detecting the interruption in the communication services of the subscriber comprises:
means for noting a signal strength from the user equipment of the subscriber;
means for comparing the signal strength to a threshold signal strength; and,
means for declaring the communication services of the subscriber interrupted when the signal strength falls below the threshold signal strength with a predetermined number of times.
